(19) United States
(12) Patent Application Publication
(10) Pub. No.: US 2004/0101196 A1
(43) Pub. Date: May 27, 2004

(54) Method and means for mobile capture, processing, storage and transmission of test and mixed information containing characters and images

(76) Inventor: Jacob Weitman, Djursholm (SE)

Correspondence Address: BIRCH STEWART KOLASCH & BIRCH, PO BOX 747, FALLS CHURCH, VA, 22040-0747, US

(21) Appl. No.: 10/333,066

(22) PCT Filed: Jul. 16, 2001
(86) PCT No.: PCT/SE01/01637

(30) Foreign Application Priority Data
Jul. 19, 2000 (SE) 0000273.7
Nov. 17, 2000 (SE) 0004231.7

(51) Int. Cl. G06K 9/34

(52) U.S. Cl. 382/173; 348/222.1

(57) ABSTRACT

Method for mobile intelligent capture, processing, storage and transmission of mixed information of text and images by means of a digital camera with microprocessor and software, characterised thereby that the entire image is first analyzed with microprocessor and software, characterized thereby that the entire image is first analyzed with respect to its text information, whereupon the original image is segmented into a text block and a picture block, that the text block is interpreted by means of, e.g., OCR-techniques and converted and compressed to a code such as ASCII-code, that the next code is supplemented by graphical information allowing the creation of a synthetic text block image, which by an overlay technique is compared with the original text block in order to assess the quality of the interpretation and that the text and picture blocks are tagged with relevant information for database handling, so that they can ve individually stored, processed and transmitted and when desired recombined for optimal reproduction on a chosen format. Also means for realizing the method, characterized primarily thereby that the digital camera allows ultra-wide angle imaging and that distortions and overlapping of images captured by, e.g., a facet lens are numerically corrected.

There are numerous situations where there is a genuine need to capture quickly, efficiently and in a simple way large amounts of information in the form of text or text+ images, without access to technical resources such as copying machines, scanners, faxes and computers, today frequently available at offices. As an example of a situation where the present invention would be highly useful we may take a journey by air, where the traveller just read an interesting, by images and diagrams possibly illustrated article in, let say, Financial Times and where the traveller either wishes to as quickly as possible transmit the corresponding information to a colleague or to save the article as reference material for himself and others. Today, this reader has the option to either tear out the interesting pages or to take along the complete newspaper. During a conference trip or another longer journey the situation may repeat itself, resulting in a cumbersome practical paper-handling problem.

There is a vast number of similar situations, where one wishes to be able to collect and/or to transfer printed information which one has received, without being limited by or dependent on an office with modern resources, such as, e.g., when reading or working in bed due to illness or laziness.

The aim of the present invention is to solve in an efficient, practical and flexible way the problem thus indicated. The solution is based on a combination and further development of available technologies, primarily digital photography, intelligent image processing incl. OCR, vector graphics, data compression, broadband data transmission and database handling.

The basis for the invention is the use of a compact digital camera, preferably equipped with optics for wide angle, large aperture and a large depth of sharpening also at short distances, where the intelligence is based on software for processing and interpretation of the entire image in such a way that those parts containing text are recognized and transformed to and stored as, e.g., ASCII- or EBCDIC-code, while the remaining parts are stored as an image with desired resolution.

A special characteristic of the method according to the invention is furthermore that the software has intelligence for the interpretation of image qualities such as font and layout and the ability to use the interpretation to recreate/synthesize a picture, which is matched against (laid over) the original text. In case of acceptable result of the matching, those parts of the original image, which contain blocks of text, are deleted, where after the information stored consists of coded text, layout information and uninterpreted image parts.

In those cases where an acceptable match of the original and the recreated/synthesized images of the text blocks has not been achieved, the raw image is stored in its original format. The result of the matching may, e.g., be expressed as the percentage of dots in agreement. Also in case of a percentage-wise very good match there may be single characters, words or passages, which have not been correctly interpreted. Such uninterpreted or incorrectly interpreted original information is not deleted from the text block, but rather displayed as a suitably marked image insert in the interpreted text. The user thereby has the opportunity to thereafter intervene and help the programme with the interpretation of the sections thus marked.

A further characteristic of the method according to the Invention is that the interpretation software, which in a preferred embodiment of the invention is installed in the camera itself, but which also may be implemented in an external unit, includes algorithms based on vector graphical methods for analyzing and storing information about the layout of the original image and that this information is used in context with the matching procedure of the original and the synthesized images and, optionally, when later printing out the synthetic image, in order to recreate 8 layout which is adapted to the print out format chosen (e.g. A4) and as closely as possible reproduces the original layout. This is important, because the layout (including aspects such as under linings, italics, subdivision in sections, etc.) may be important for the understanding of content and context.

As an option, the camera may be provided with framing functions, so that only specifically chosen parts of the image are stored and processed, whereby text or image information, which is regarded as dispensable (such as a picture with a blue sky and a swaying cornfield in an article about our environment, or a picture of a provocative female in an article on the roles of the sexes)) is eliminated already at source.

According to the invention, the information may be tagged already by the software of the intelligent camera, so that later handling of information in databases is facilitated. This is achieved by inherent functionality for the automatic recognition of such characteristics as headings and names of authors, as well as automatic selection of keywords out of headings.

For greater versatility the software of the intelligent camera may be extended by options for translation between various languages and/or for Interpretation of mathematical symbols and formulas and/or recognition Of one or several handwritings. The handwriting recognition may be preferably based on algorithms for self-learning in neural systems.

Depending on the state of development with respect to memory and processor capacities, as much as possible of the intelligence is located within the camera itself. However, functions and options, which at a given state of development are regarded as too demanding from the point of view of memory or processor capacity and performance, may be implemented and executed externally, whereby high-speed communication protocols (such as FIRE WiRE 1394) may be very useful.

Connecting the intelligent mobile digital camera to a mobile phone with broadband transmission capacity will enable transmission of interpreted and compressed data to one's own database or to third parties. The transmission may be performed either in real time or delayed, based on stored data.

A practically important characteristic of the means according to the invention is that the camera may be equipped for ultra-wide-angle photography, so that, e.g., a whole page of the initially mentioned newspaper publication can be captured in one exposure at a normal distance of observation (0.3 to 0.5 m). This may be achieved either by means of special wide angle lenses, whereby distortions are corrected numerically, or by facet lenses according to the apposition or superposition principle, whereby a complete image is synthesized computationally, or by optics with a scanning arrangement such as a moving mirror, in which case the complete picture is also composed by the software.

Within the scope of the invention, it is of course allowed that the intelligent camera may be used as a conventional digital camera as well.

1. Method for mobile intelligent capture, processing, storage and transmission of text and mixed information of text and images, comprising a digital camera with microprocessor, memory and software, characterized thereby that the entire image taken by the camera is analyzed with respect to its text information, that said information is recognized and interpreted by, e.g., OCR techniques and is stored as compressed text code, for further processing and/or transmission.

2. Method according to claim 1, characterized thereby that text properties such as font, under linings, bold print, etc., are recognized and added to the interpreted text.

3. Method according to claims 1 and 2, characterized thereby that the original text is analyzed with respect to other specific information, such as subdivision in paragraphs and layout and that the total assembled information about the interpreted text is used to create a synthetic text image, which is compared to the original text image and that the latter is deleted from the memory of the camera when there is a sufficiently good match between the original and the synthetic image.

4. Method according to claim 3, characterized thereby that text information, which could not be interpreted, is not deleted but displayed in the interpreted/synthetic text as a suitably marked image of the pertinent original character/word/paragraph.

5. Method according to claims 1-4, characterized thereby that the original image is segmented into two blocks, whereby one block contains the interpreted text information and the other block the remaining relevant information from the original image and that these blocks are tagged such that they can be processed and transmitted individually and whenever desired recombined to create a reproduction of the original image.

6. Method according to claims 1-5, characterized thereby that in context with reproduction of the recombined image on another format than the format of the original image, the reproduction is performed such that the layout of the reproduced image agrees as closely as possible with that of the original image.

7. Method according to claims 1-6, characterized thereby that the text information is automatically analyzed with regard to and tagged by such characteristics as name of author and publication and keywords out of headings, thereby facilitating systematic storage and retrieval of information in databases.

8. Means for mobile intelligent capture, processing, storage and transmission of text and mixed information of text and images, comprising a digital camera with microprocessor, memory and software, characterized thereby that the lens of the camera is designed for ultra-wide-angle.

9. Means according to claim 8, characterized thereby that distortion in the lens are numerically corrected, so that an undistorted image can be recreated.

10. Means according to claim 8, characterize thereby that the tens is designed as a facet lens according to the apposition principle, with certain overlapping between the partial images and that a continuous total image is produced by the software.

11. Means according to claim 8, characterized thereby that the lens is designed as a facet lens according to the superposition principle and that, when required, distortions are corrected by the software.
